(19) United States
(12) Patent Application Publication
(10) Pub. No.: US 2014/0168102 A1
(43) Pub. Date: Jun. 19, 2014

(54) ELECTRONIC DEVICE AND METHOD FOR PROVIDING TACTILE STIMULATION

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: SHANG-QING ZHOU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/729,008

(22) Filed: Dec. 27, 2012

(30) Foreign Application Priority Data
Dec. 13, 2012 (CN) 201210538630.5

(51) Int. Cl. G06F 3/041

(52) U.S. Cl. CPC G06F 3/041
USPC 345/173

(57) ABSTRACT

A method for providing tactile stimulation is applied in an electronic device. The electronic device includes a touch-sensitive screen and a tactile stimulation multilayer connected to the touch-sensitive screen. The method includes the following steps: detecting whether a touch operation is a long press operation according to touch signals from the touch-sensitive screen; obtaining position information of touched positions if the touch operation is a long press operation; determining a number of continuous electrodes corresponding to the touched positions of the long press operation according to a first relationship between the positions and the electrodes; and energizing the continuous electrodes via a power supply unit by gradually changing electrical parameters.

### BACKGROUND

1. Technical Field

The present disclosure relates to electronic devices, and particularly, to an electronic device and a method for providing tactile stimulation adapted for the electronic device.

2. Description of Related Art

Many electronic devices, such as mobile phones, tablet computers, and multimedia players, usually employ touch-sensitive screens as input interfaces. When a user presses one virtual graphical button or icon displayed on a touch-sensitive screen, the graphical button or icon does not provide very good tactile feedback to the user as a conventional keyboard does which has a travel distance for a keystroke when operated. In order to improve the user experience, a number of vibrating mechanical members are arranged under the touch-sensitive screen. When sensing a touch operation on the touch-sensitive screen, the vibrating mechanical member at a corresponding location begins to vibrate to provide tactile feedback to the user. However, a problem shared by most such electronic devices is that such vibration-based tactile sensation tends to be mundane.

Recently, a new technology of enabling the touch-sensitive screen to provide tactile feedback is realized by delivering an electrosensory sensation to the user touching the touch-sensitive screen. However, there is less developments on how this kind of tactile feedback is applied in response to a touch gesture to bring a new level of tactile experience to the user.

Therefore, what is needed is a means to solve the problem described above.

### BRIEF DESCRIPTION OF THE DRAWINGS

Many aspects of the present disclosure should be better understood with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a perspective view of a touch-sensitive screen included in an electronic device, in accordance with an exemplary embodiment.

FIG. 2 is a perspective view of a tactile stimulation multilayer connected to the touch-sensitive screen of FIG. 1, in accordance with an exemplary embodiment.

FIG. 3 is a block diagram of a tactile stimulation system applied to the electronic device of FIG. 1, in accordance with an exemplary embodiment.

FIG. 4 is a flowchart of a method for providing tactile stimulation, in accordance with an exemplary embodiment.

### DETAILED DESCRIPTION

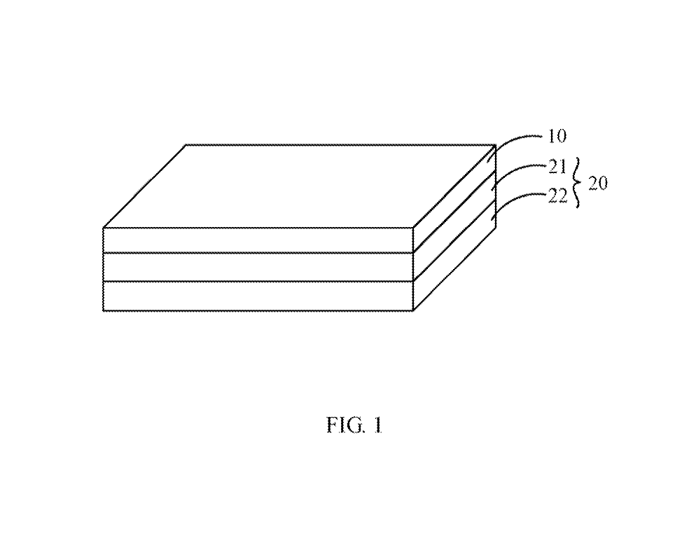

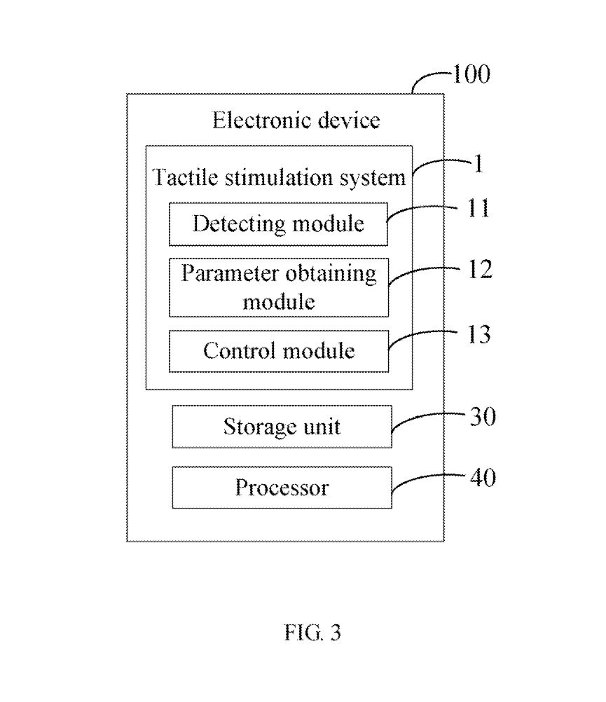

FIG. 1 is a perspective view of a touch-sensitive screen 10 according to an exemplary embodiment. The screen 10 is included in an electronic device 100. The electronic device 100 may be a mobile phone, a tablet computer, or a multimedia player. A tactile stimulation multilayer 20 is connected to the screen 10, and is arranged above or under the screen 10. The multilayer 20 includes a number of electrodes 220 (further shown in FIG. 3) which can be independently controlled. The electronic device 100 further includes a storage unit 30 and a processor 40 (further shown in FIG. 3). The storage unit 30 stores a first relationship between a number of positions of the screen 10 and the electrodes 220. Each position corresponds to one electrode 220. The storage unit 30 further stores a tactile stimulation system 1. The system 1 includes a variety of modules executed by the processor 40 to provide the functions of the system 1. In this embodiment, the system 1 is executed by the processor 40 to detect touch operation on the screen 10 by an object (e.g., a body member to be stimulated, such as a finger) and employ position information of the touch operation to energize the corresponding electrode 220 in the multilayer 20 to provide tactile stimulation. A detail description of the tactile stimulation multilayer 20 will be described as follows.

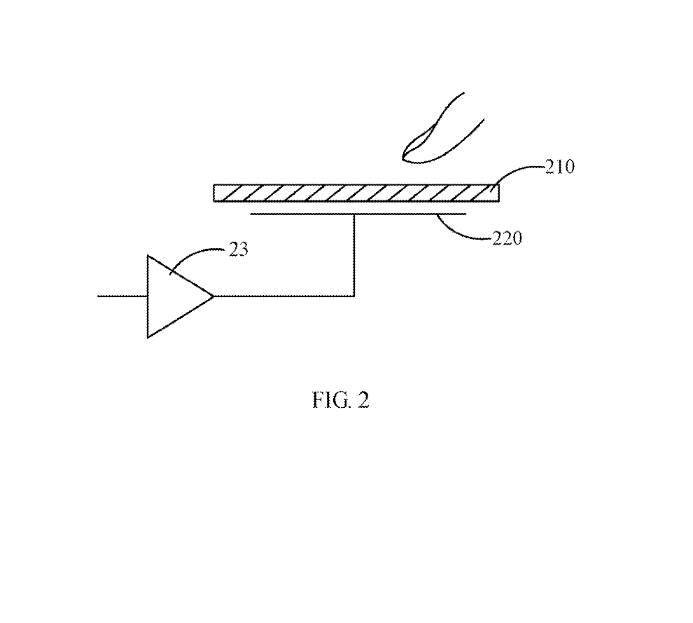

Referring to FIG. 2, the multilayer 20 includes an insulation layer 21 and an electrode layer 22. The said electrodes 220 are included in the electrode layer 22. The electrodes 220 are connected to a power supply unit 23, and can be independently energized via the power supply unit 23. The insulation layer 21 includes a number of insulators 210, and each insulator 210 corresponds to one electrode 220. In the embodiment, the multilayer 20 is arranged under the screen 10, and the insulation layer 21 is arranged between the multilayer 20 and the electrode layer 22. Furthermore, when a body member which is a relatively good insulator when dry touches the multilayer 20, the body member and the multilayer 20 cooperatively form a imaginary capacitor. Then, the system 1 determines the position of the body member on the screen 10 and energizes the electrode 220 corresponding to the determined position via the power supply unit 23. Thus, static charges generated on the body member because of a capacitive coupling between the determined electrode 220 and the body member, and the generated static charges flows to form electric current which delivers a tactile stimulation to the body member.

FIG. 3 shows that in the embodiment, the system 1 includes a detecting module 11, a parameter obtaining module 12, and a control module 13.

The detecting module 11 detects whether a touch operation on the screen 10 is a long press operation according to touch signals from the screen 10. The long press operation is a touch held in the same position of the screen 10 for a moment.

The parameter obtaining module 12 obtains position information of touched positions if the touch operation is a long press operation. In the embodiment, when an object touches on the screen 10, a number of positions of the screen 10 are simultaneously touched, thus each time when a touch operation is executed, position information of a number of touched positions are obtained.

The control module 13 determines a number of continuous electrodes 220 corresponding to the touched positions of the long press operation according to the first relationship between the positions and the electrodes 220 stored in the storage unit 30. The control module 15 further energizes the continuous electrodes 220 via the power supply unit 23 by gradually changing electrical parameters. Thus, an improved tactile stimulation is provided to the object touched on the screen 10. In the embodiment, the electrical parameter is the amplitude or frequency of electric current energizing the electrodes 220. In the embodiment, the control unit 13 energizes the continuous electrodes 220 via the power supply unit 23 by gradually increasing amplitudes of electric current, thus a gradually strengthening tactile stimulation is provided to the object touched on the screen 10. In an alternative embodiment, the control unit 13 may energize the continuous electrodes 220 via the power supply unit 23 by gradually decreasing amplitudes of electric current, thus a gradually weakening tactile stimulation is provided to the object touched on the screen 10. It is notable that the way to change the electrical parameters is not limited and can be varied as needed, such as to periodically increase the amplitudes of electric current.

In the embodiment, the storage unit 30 further stores a second relationship between different graphic icons and energizing ways of the electrodes 220. Each graphic icon corresponds to one energizing way. When determining the electrodes 220 corresponding to the touched positions, the control module 14 further determines a graphic icon displayed on the touched positions according to the position information of the touched positions, determines one energizing way to energize the electrodes 220 corresponding to the touched positions according to the second relationship, and then energizes the continuous electrodes 220 via the power supply unit 23 according to the determined energizing way. Thus, different characteristics of the tactile stimulation can be generated when the object touches different graphic icons on the screen 10.

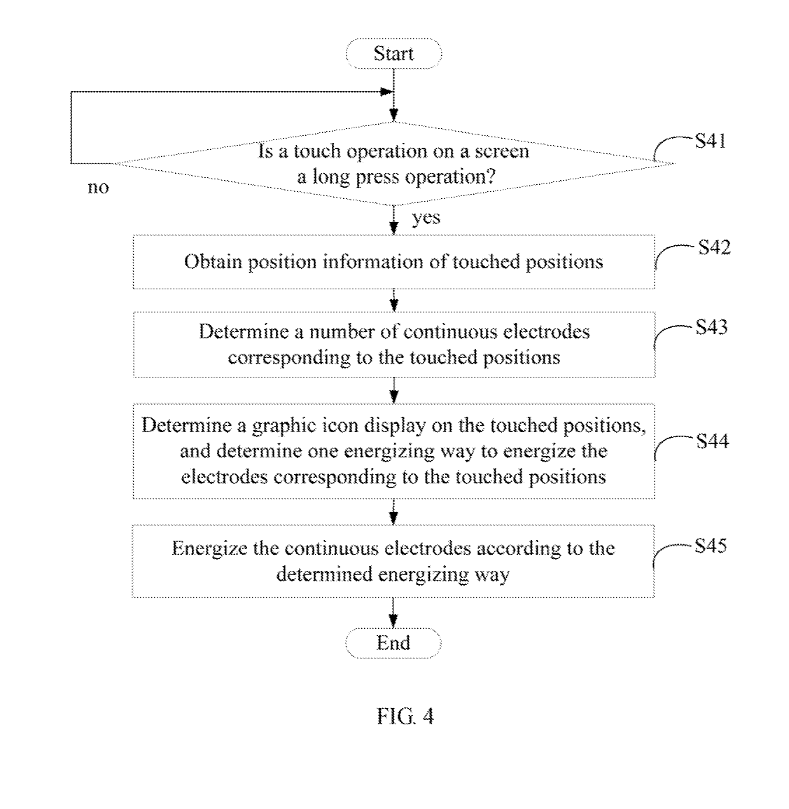

FIG. 4 is a flowchart of a method for providing tactile stimulation, in accordance with an exemplary embodiment.

In step S41, the detecting module 11 detects whether a touch operation on the screen 10 is a long press operation according to touch signals from the screen 10, if yes, the procedure goes to step S42; otherwise, the procedure goes to back to step S41.

In step S42, the parameter obtaining module 12 obtains position information of touched positions if the touch operation is a long-press operation. In the embodiment, when an object touches on the screen 10, a number of positions of the screen 10 are simultaneously touched, thus each time when a touch operation is executed, position information of a number of touched positions are obtained.

In step S43, the control module 13 determines a number of continuous electrodes 220 corresponding to the touched positions of the long press operation according to the first relationship between the positions and the electrodes 220 stored in the storage unit 30.

In step S44, the control module 14 determines a graphic icon displayed on the touched positions according to the position information of the touched positions, and determines one energizing way to energize the electrodes 220 corresponding to the touched positions according to the second relationship between different graphic icons and energizing ways of the electrodes 220.

In step S45, the control module 14 energizes the continuous electrodes 220 via the power supply unit 23 according to the determined energizing way.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
a touch-sensitive screen;
a tactile stimulation multilayer connected to the touch-sensitive screen, the tactile stimulation multilayer comprising a plurality of electrodes;
a storage unit storing a plurality of modules and a first relationship between positions of the touch-sensitive screen and the electrodes, each position corresponding to one of the electrodes; and
a processor to execute the plurality of modules, and the plurality of modules comprising:
a detecting module to detect whether a touch operation is a long press operation according to touch signals from the touch-sensitive screen;
a parameter obtaining module to obtain position information of touched positions if the touch operation is a long press operation; and
a control module to determines a plurality of continuous electrodes corresponding to the touched positions of the long press operation according to the first relationship between the positions and the electrodes, and energize the continuous electrodes via a power supply unit by gradually changing electrical parameters.

2. The electronic device of claim 1, wherein the electrical parameter is the amplitude or frequency of electric current.

3. The electronic device of claim 2, wherein the control unit is configured to energize the continuous electrodes via the power supply unit by gradually increasing amplitudes of the electric current.

4. The electronic device of claim 2, wherein the control unit is configured to energize the continuous electrodes via the power supply unit by gradually decreasing amplitudes of electric current.

5. The electronic device of claim 2, wherein the control unit is configured to energize the continuous electrodes via the power supply unit by periodically increasing amplitudes of electric current.

6. The electronic device of claim 1, wherein the storage unit is further configured to store a second relationship between different graphic icons and energizing ways of the electrodes, each graphic icon corresponds to one energizing way; the control module is further configured to determine a graphic icon displayed on the touched positions according to the position information of the touched positions, determine one energizing way to energize the electrodes corresponding to the touched positions according to the second relationship, and energize the continuous electrodes via the power supply unit according to the determined energizing way.

7. A method for providing tactile stimulation applied in an electronic device, the electronic device comprising a touch-sensitive screen and a tactile stimulation multilayer connected to the touch-sensitive screen, the tactile stimulation multilayer comprising a plurality of electrodes, the method comprising:
detecting whether a touch operation is a long press operation according to touch signals from the touch-sensitive screen;
obtaining position information of touched positions if the touch operation is a long press operation;
determining a plurality of continuous electrodes corresponding to the touched positions of the long press operation according to a first relationship between the positions and the electrodes stored in the electronic device; and
energizing the continuous electrodes via a power supply unit by gradually changing electrical parameters.

8. A storage medium storing a plurality of modules, the plurality of modules comprising instructions executable by a processor of an electronic device to perform a method for providing tactile stimulation, the electronic device comprising a touch-sensitive screen and a tactile stimulation multilayer connected to the touch-sensitive screen, the tactile stimulation multilayer comprising a plurality of electrodes, the method comprising:
storing a first relationship between positions of the touch-sensitive screen and the electrodes stored in the electronic device, wherein each position corresponding to one of the electrodes;
detecting whether a touch operation is a long press operation according to touch signals from the touch-sensitive screen;
obtaining position information of touched positions if the touch operation is a long press operation;
determining a plurality of continuous electrodes corresponding to the touched positions of the long press operation according to the first relationship between the positions and the electrodes; and
energizing the continuous electrodes via a power supply unit by gradually changing electrical parameters.
